(19) United States
(12) Patent Application Publication
(10) Pub. No.: US 2024/0287365 A1
(43) Pub. Date: Aug. 29, 2024

(54) Ice-Melting Sheet Device

(71) Applicant: Gregory Davis, Whitehall, PA (US)

(72) Inventor: Gregory Davis, Whitehall, PA (US)

(21) Appl. No.: 18/321,229

(22) Filed: May 22, 2023

Related U.S. Application Data
(60) Provisional application No. 63/447,935, filed on Feb. 24, 2023.

(51) Int. Cl. C09K 3/18

(52) U.S. Cl. CPC C09K 3/185

(57) ABSTRACT

An ice-melting sheet device is provided. The device is comprised of a dissolving body with an integrated melting compound that is released once the body melts. The melting compound is preferably a rock salt or other compound that can melt ice or snow.

### CROSS-REFERENCE TO RELATED APPLICATION

The present application claims priority to, and the benefit of, U.S. Provisional Application No. 63/447,935, which was filed on Feb. 24, 2023, and is incorporated herein by reference in its entirety.

### FIELD OF THE INVENTION

The present invention relates generally to the field of de-icing devices. More specifically, the present invention relates to an ice-melting sheet device comprised of a water-soluble body with at least one melting compound. The body can be placed over an area of ice or snow, such that the body dissolves and distributes the melting compound over the area to melt the snow or ice. Accordingly, the present disclosure makes specific reference thereto. Nonetheless, it is to be appreciated that aspects of the present invention are also equally applicable to other like applications, devices, and methods of manufacture.

### BACKGROUND

Snow and ice may accumulate on roadways, sidewalks, and other pedestrian walkways. This can be incredibly dangerous if an individual slips and falls on the snow or ice, as they can suffer serious injury. However, trying to remove snow and ice with just a shovel can be a difficult and exhausting process. As a result, individuals may be forced to purchase snow blowers and salt to remove snow and ice from the walkway which can become expensive.

Therefore, there exists a long-felt need in the art for a device for melting snow and ice. More specifically, there exists a long-felt need in the art for an ice-melting sheet device. There also exists a long-felt need in the art for an ice-melting sheet device that can be applied over an area to melt snow or ice in said area. In addition, there exists a long-felt need in the art for an ice-melting sheet device that can be applied over an area to melt snow or ice in said area wherein the device is low cost. Further, there exists a long-felt need in the art for an ice-melting sheet device that can be applied over an area to melt snow or ice in said area wherein the device is easy to use and does not require significant physical energy expenditure.

The subject matter disclosed and claimed herein, in one embodiment thereof, comprises an ice-melting sheet device. The device may be comprised of a body with a top surface comprised of a first compound and a bottom surface comprised of a second compound. The body is preferably water-soluble such that it dissolves when placed on ice or snow. The second compound is comprised of a melting compound, such as rock salt. The first compound is comprised of a granulated compound, such as sand. Once the body is placed over an area of ice or snow, the body dissolves such that the melting compound is distributed over the area to melt the snow/ice. In addition, the granulated compound is distributed over the melting compound to provide traction for walking over the area.

In this manner, the ice-melting sheet device of the present invention accomplishes all the foregoing objectives and provides a device for melting snow and ice that can be applied over an area to melt snow or ice on said area. In addition, the device is low cost. Further, the device is easy to use and does not require significant physical energy expenditure.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an ice-melting sheet device comprised of a body with a top surface comprised of a first compound and a bottom surface comprised of a second compound. In the preferred embodiment, the body is square. The body may be made from a water-soluble adhesive material or a water-soluble paper-based material.

The bottom surface of the body is comprised of at least one compound which is preferably rock salt (or any melting salt of the like). The compounds melt ice or snow that the bottom surface contacts during use. The top surface of the body may also be comprised of at least one compound. Said compound may be the same ice-melting compound as the bottom surface. In another embodiment, the compound may be comprised of a material that improves traction on ice, such as, but not limited to, sand or other granulated material.

During use, the body can be placed over ice or snow on a ground surface. After being placed over the ice, the body melts, due to the ice and/or snow, such that the compound of the bottom surface is distributed onto the ice. Further, the compound of the top surface may also be distributed over the compound of the bottom surface in a layered fashion.

The present invention is also comprised of a method of using the device. First, a device is provided comprised of a body comprised of at least one compound. Then, the body is placed over an area of ice or snow on a ground surface such that the body melts to distribute the compound over the ice, and wherein the compound then melts the ice.

Accordingly, the ice-melting sheet device of the present invention is particularly advantageous as it provides a device for melting snow and ice that can be applied over an area to melt snow or ice in said area. In addition, the device is low cost. Further, the device is easy to use and does not require significant physical energy expenditure. In this manner, the ice-melting sheet device overcomes the limitations of existing methods of snow and ice removal known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of an ice-melting sheet device of the present invention while placed over ice on a ground surface in accordance with the disclosed architecture;

FIG. 2 illustrates a perspective view of one potential embodiment of a plurality of ice-melting sheet devices of the present invention while stored around a roll in accordance with the disclosed architecture; and

FIG. 3 illustrates a flowchart of a method of using one potential embodiment of an ice-melting sheet device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device for melting snow and ice. More specifically, there exists a long-felt need in the art for an ice-melting sheet device. There also exists a long-felt need in the art for an ice-melting sheet device that can be applied over an area to melt snow or ice in said area. In addition, there exists a long-felt need in the art for an ice-melting sheet device that can be applied over an area to melt snow or ice in said area wherein the device is low cost. Further, there exists a long-felt need in the art for an ice-melting sheet device that can be applied over an area to melt snow or ice in said area wherein the device is easy to use and does not require significant physical energy expenditure.

The present invention, in one exemplary embodiment, is comprised of an ice-melting sheet device comprised of a body with a top surface comprised of a first compound and a bottom surface comprised of a second compound. In the preferred embodiment, the body is square and may be made from a water-soluble adhesive material or a water-soluble, paper-based material. The bottom surface of the body is comprised of at least one compound which is preferably rock salt (or any melting salt of the like). The compounds melt ice or snow that the bottom surface contacts during use.

Similarly, the top surface of the body may also be comprised of at least one compound. Said compound may be the same ice-melting compound as the bottom surface. In another embodiment, the compound may be comprised of a material that improves traction on ice, such as, but not limited to, sand or other granulated material. To use the device, the body can be placed over ice or snow on a ground surface wherein the body melts due to the ice and/or snow such that the compound of the bottom surface is distributed onto the ice. Further, the compound of the top surface may also be distributed over the compound of the bottom surface in a layered fashion.

The present invention is also comprised of a method of using the device. First, a device is provided comprised of a body comprised of at least one compound. Then, the body is placed over an area of ice or snow on a ground surface such that the body melts to distribute the compound over the ice, and wherein the compound then melts the ice.

Accordingly, the ice-melting sheet device of the present invention is particularly advantageous as it provides a device for melting snow and ice that can be applied over an area to melt snow or ice in said area. In addition, the device is low cost. Further, the device is easy to use and does not require significant physical energy expenditure. In this manner, the ice-melting sheet device overcomes the limitations of existing methods of snow and ice removal known in the art.

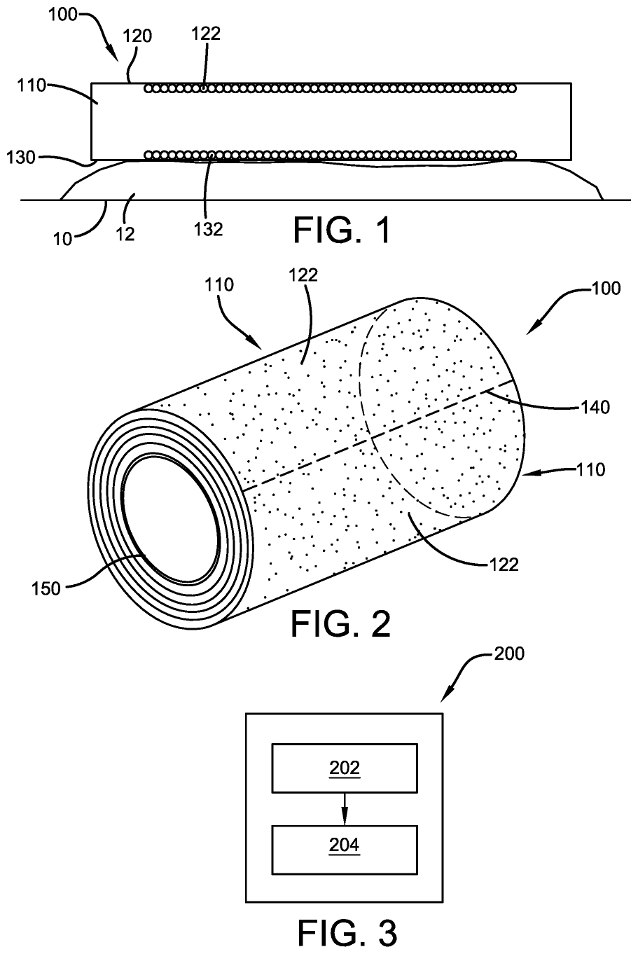

Referring initially to the drawings, FIG. 1 illustrates a side view of one potential embodiment of an ice-melting sheet device 100 of the present invention while placed over ice 12 on a ground surface 10 in accordance with the disclosed architecture. The device 100 is comprised of a body 110 with a top surface 120 comprised of a first compound 132 and a bottom surface 130 comprised of a second compound 132. In differing embodiments, the body 110 may be any shape known in the art. The body 110 may also be any length, width, and thickness in different embodiments to cover any size area. In one embodiment, a plurality of bodies 110 are stored in a connected fashion to one another via at least one tearable perforation 140 and around at least one roll 150, as seen in FIG. 2. In another embodiment, the body 110 may be individually packaged.

In the preferred embodiment, the body 110 is square. The body 110 may be made from a water-soluble adhesive material that allows the body to be stuck to a ground surface. In another embodiment, the body 110 is made from a water-soluble, paper-based material.

The bottom surface 130 of the body 110 is comprised of at least one compound 132. The compound 132 is preferably rock salt (or any melting salt of the like) that can be used to dissolve ice 12 that the bottom surface 130 contacts during use. However, in different embodiments, the compound 132 may be made from any other ice-melting compound known in the art such as, but not limited to, calcium, magnesium, potassium, chloride, etc. In one embodiment, the top surface 120 may also be comprised of the same compound 122 as the bottom surface compound 132.

As noted, the compound 122 of the top surface 120 of the body 110 is comprised of at least one compound 122. The compound 122 may be the same ice-melting compound 132 as the bottom surface 130. However, in one embodiment, the compound 122 of the top surface 120 may be comprised of a material that improves traction on ice, such as, but not limited to, sand or other granulated material.

During use, the body 110 can be placed over ice 12 (or snow) on a ground surface 10. After being placed over the ice 12, the body 110 melts due to the ice 12 and/or snow on the ground surface 10. Once the body 110 melts, the compound 132 of the bottom surface 130 is distributed onto the ice 12. Further, the compound 122 of the top surface 120 is distributed over the compound 132 of the bottom surface 130 in a layered fashion. As a result, the body 110 can simply be placed over ice 12 such that the body 110 automatically melts and places a melting compound 132 on the ice 12 (and potentially a traction compound 122 over the melting compound 132).

In one embodiment, the compounds 122,132 may protrude partially (i.e., positioned on) from the top surface 120 and bottom surface 130, such that the compounds 122,132 are effective before the body 110 fully melts. In another embodiment, the compounds 122,132 are fully embedded in the body 110, such that the compounds 122,132 are not effective until the body 110 fully melts.

The present invention is also comprised of a method of using 200 the device 100, as seen in FIG. 3. First, a device 100 is provided comprised of a body 110 comprised of at least one compound 132 [Step 202]. Then, the body 110 is placed over an area of ice 12 or snow on a ground surface 10, such that the body melts to distribute the compound 132 over the ice 12, and wherein the compound 132 then melts the ice 12 [Step 204].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “ice-melting sheet device” and “device” are interchangeable and refer to the ice-melting sheet device 100 of the present invention.

Notwithstanding the foregoing, the ice-melting sheet device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the ice-melting sheet device 100 as shown in the FIGS. are for illustrative purposes only, and that many other sizes and shapes of the ice-melting sheet device 100 are well within the scope of the present disclosure. Although the dimensions of the ice-melting sheet device 100 are important design parameters for user convenience, the ice-melting sheet device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An ice-melting sheet device comprising:
a water-soluble body; and
a melting compound positioned within the body.

2. The ice-melting sheet device of claim 1, wherein the water-soluble body is comprised of a water-soluble adhesive material.

3. The ice-melting sheet device of claim 1, wherein the water-soluble body is comprised of a water-soluble paper material.

4. The ice-melting sheet device of claim 1, wherein the melting compound is comprised of a rock salt.

5. The ice-melting sheet device of claim 1, wherein the melting compound is comprised of a calcium, a magnesium, a potassium, or a chloride compound.

6. An ice-melting sheet device comprising:
a water-soluble body comprised of a top surface and a bottom surface;
a traction compound; and
a melting compound.

7. The ice-melting sheet device of claim 6, wherein the water-soluble body is comprised of a water-soluble adhesive material.

8. The ice-melting sheet device of claim 6, wherein the water-soluble body is comprised of a water-soluble paper material.

9. The ice-melting sheet device of claim 6, wherein the melting compound is comprised of a rock salt.

10. The ice-melting sheet device of claim 6, wherein the melting compound is comprised of a calcium, a magnesium, a potassium, or a chloride compound.

11. The ice-melting sheet device of claim 6, wherein the traction compound is comprised of a sand.

12. The ice-melting sheet device of claim 6, wherein the traction compound is comprised of a granulated material.

13. The ice-melting sheet device of claim 6, wherein the traction compound is positioned on the top surface.

14. The ice-melting sheet device of claim 6, wherein the traction compound is positioned in the top surface.

15. The ice-melting sheet device of claim 6, wherein the melting compound is positioned on the bottom surface.

16. The ice-melting sheet device of claim 6, wherein the melting compound is positioned in the bottom surface.

17. The ice-melting sheet device of claim 6, wherein the body is comprised of a perforation.

18. The ice-melting sheet device of claim 6, wherein the body is positioned around a roll.

19. A method of using an ice-melting sheet device, the method comprising:
providing an ice-melting sheet device comprised of a water-soluble body comprised of a melting compound; and
placing the body over an area of ice or snow on a ground surface such that the water-soluble body melts to distribute the melting compound over the ice.

20. The method of claim 19, wherein the melting compound is comprised of a rock salt.
